(19) United States
(12) Patent Application Publication
(10) Pub. No.: US 2007/0223772 A1
(43) Pub. Date: Sep. 27, 2007

(54) Speaker

(75) Inventor: Hiroshi Kaiwa, Tendo (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION, Tokyo (JP); TOHOKU PIONEER CORPORATION, Tendo-shi (JP)

(21) Appl. No.: 11/717,103

(22) Filed: Mar. 13, 2007

(30) Foreign Application Priority Data
Mar. 13, 2006 (JP) 2006-068301

(51) Int. Cl. H04R 9/06; H04R 1/00; H04R 11/02

(52) U.S. Cl. 381/398; 381/433

(57) ABSTRACT

The present invention is to provide a speaker to prevent deterioration of sound characteristics and to be easily inspected with eyes about a cause to deteriorate the sound characteristics. The speaker includes a magnetic circuit and a vibration portion. The magnetic circuit forms a magnetic gap and the vibration portion has a voice coil, a drive cone, and a diaphragm. The voice coil accepts signal current and is disposed in the magnetic gap. The drive cone is attached to the voice coil and has an upstanding segment at an outer edge of the drive cone. The diaphragm is superposed on the drive cone and the outer edge thereof is spaced from the upstanding segment. An adhesive agent is filled between the outer edge of the diaphragm and the upstanding segment to be fixed to the drive cone.

### BACKGROUND OF THE INVENTION

1. Field of the Invention

The present invention relates to a speaker for generating sound by vibrating a diaphragm with signal current supplied.

2. Description of the Related Art

A variety of speakers have been equipped in motor vehicles as disclosed in, for example, JP-1′-75291-A, JP-H11-168794-A, and JP-H11-168795-A. The conventional speakers each include a cabinet, a vibration portion attached to the cabinet, and a magnetic circuit received in the cabinet for generating sound by vibrating the vibration portion.

The cabinet is formed in a flat box shape. The vibration portion includes a voice coil for accepting signal current, a drive cone attached to the voice coil, and a diaphragm attached to the drive cone. An outer edge of a plate-shaped diaphragm is superposed on an outer edge of the drive cone, and both the drive cone and the diaphragm are fixed together with an adhesive agent applied between the both outer edges.

When the signal current is supplied to the voice coil of the speaker, the voice coil vibrates the drive cone and the diaphragm in cooperation with the magnetic circuit responsive to the signal current.

In the conventional speaker, the drive cone and the diaphragm are superposed together and are fixed together by applying the adhesive agent therebetween. Flatness of the outer edge portions of the drive cone and the diaphragm and an irregular amount of the adhesive agent thus cause a thin portion of the adhesive agent applied and a non-applied portion in the superposed edge portions.

The non-applied or thin portion of the adhesive agent in the superposed edge portions accordingly causes crack in the adhesive agent between the outer edge portions of the drive cone and the diaphragm. When the drive cone and the diaphragm vibrate together, the crack allows the vibrated air to move therein and thereby deteriorates sound characteristics of the speaker.

In the conventional speaker, the adhesive agent is applied between the outer edge portions of the drive cone and the diaphragm so that a visible inspection of the crack occurred in the adhesive agent is difficult. The crack can not be found until the signal current is supplied to the magnetic circuit to vibrate the drive cone and the diaphragm. The visible inspection to find out a cause of deteriorating the sound characteristics is difficult.

### SUMMARY OF THE INVENTION

An object of the present invention is to provide a speaker to prevent the deterioration of sound characteristics and to be easily inspected with eyes about the cause to deteriorate the sound characteristics. According to a first aspect of the present invention, a speaker includes a voice coil accepting a signal current; a drive cone attached to the voice coil; a diaphragm attached to the drive cone; a magnetic circuit for vibrating the drive cone and the diaphragm in cooperation with the voice coil; wherein the drive cone and the diaphragm are superposed each other at outer edge portions thereof and fixed together with an adhesive agent, the drive cone has an upstanding segment at the outer edge thereof, the upstanding segment being spaced from the outer edge of the diaphragm, the adhesive agent is filled between the upstanding segment and the outer edge of the diaphragm to fix the drive cone and the diaphragm together.

### BRIEF DESCRIPTION OF THE DRAWINGS

FIG. 1 is a plan view of an embodiment of a speaker of the present invention;

FIG. 2 is a sectional view of FIG. 1 taken along the line II-II;

FIG. 3 is an enlarged plan view showing an essential part of a diaphragm of the speaker of FIG. 1;

FIG. 4 is an enlarged plan view showing a positioning portion of the speaker of FIG. 1;

FIG. 5 is a plan view of a drive cone of the speaker of FIG. 1; and

FIG. 6 is an enlarged sectional view of the portion of VI of FIG. 2.

### DETAILED DESCRIPTION OF THE PREFERRED EMBODIMENTS

An embodiment of the present invention is explained below. A speaker of the embodiment of the present invention includes an upstanding segment disposed on an outer edge portion of a drive cone, the upstanding segment having a spacing with respect to an outer edge of a diaphragm. An adhesive agent is filled between the upstanding segment and the outer edge of the diaphragm to fix the diaphragm and the drive cone together. The adhesive agent the diaphragm and the drive cone can be inspected with eyes about a crack therein so that a cause to deteriorate sound characteristics can be inspected with eyes.

The adhesive agent is filled between the outer edge of the diaphragm and the upstanding segment spaced from the outer edge of the diaphragm. The upstanding segment and the outer edge of the diaphragm are thus prevented from directly contacting each other even they have a rough surface. A non-applied portion of the adhesive agent therebetween is thus prevented. The crack in the adhesive agent bonding the drive cone and the diaphragm is prevented so that air generated by the diaphragm, which generates sound, does not propagate through the crack and the deterioration of the sound characteristics is prevented.

The drive cone and the diaphragm are positioned with positioning portions so as to keep the spacing between the upstanding segment and the outer edge of the diaphragm generally same around the speaker and to keep a thickness of the adhesive agent boding the drive cone and the diaphragm generally same. The extremely thin portion of the adhesive agent can be prevented so that the crack of the adhesive agent can be more assuredly prevented.

The positioning portions each include a protrusion projecting from one of the drive cone and the diaphragm, and an interference portion disposed on the other thereof so that the drive cone and the diaphragm are assuredly positioned.

An outer edge protrusion and an inner edge protrusion are disposed on a flange main body of the drive cone. The contact between the whole part of a flange of the drive cone and the diaphragm is prevented. The contacting portion between the drive cone and the diaphragm is limited to the outer and inner edge protrusions so that the random contact therebetween is prevented even when the surface thereof is rough.

The outer edge protrusion projects more than the inner edge protrusion does. The drive cone and the diaphragm contact each other at the outer edge protrusion so that the random contact therebetween is prevented even when the flatness of the flange and the diaphragm is low.

The speaker has through holes disposed between the outer and inner edge protrusions and penetrating the flange main body of the drive cone. A solvent of the adhesive agent applied to the outer edge protrusion easily diffuses outside so that the time required to harden the adhesive agent becomes shorter resulting to shortening of the manufacturing time of the speaker.

### EXAMPLE

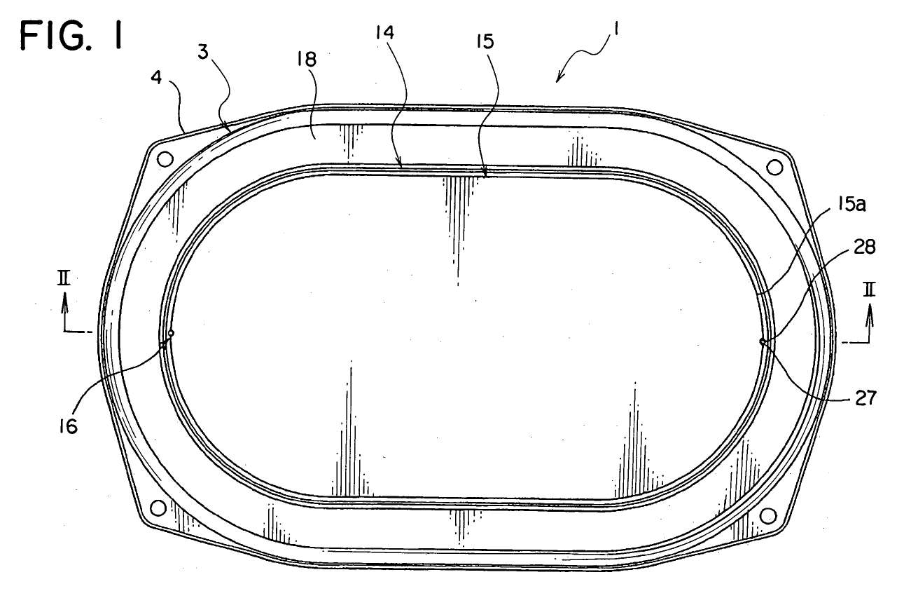

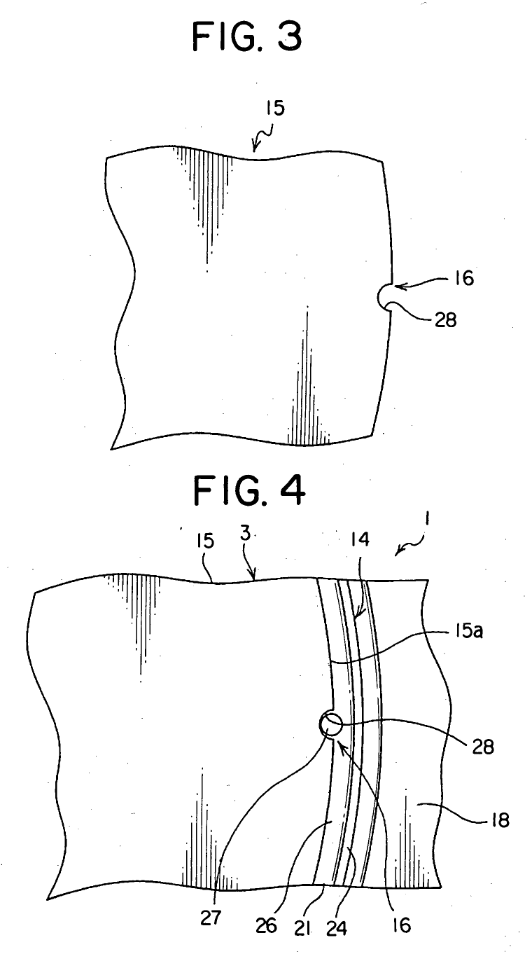

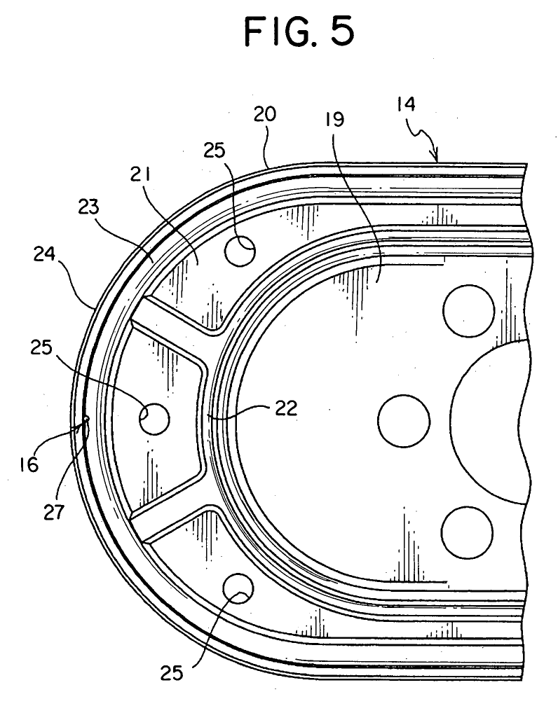

An embodiment of the present invention is explained by referring to FIGS. 1-6. FIG. 1 shows a speaker 1 of the embodiment equipped in a vehicle such as a motor vehicle for providing sound information to a passenger.

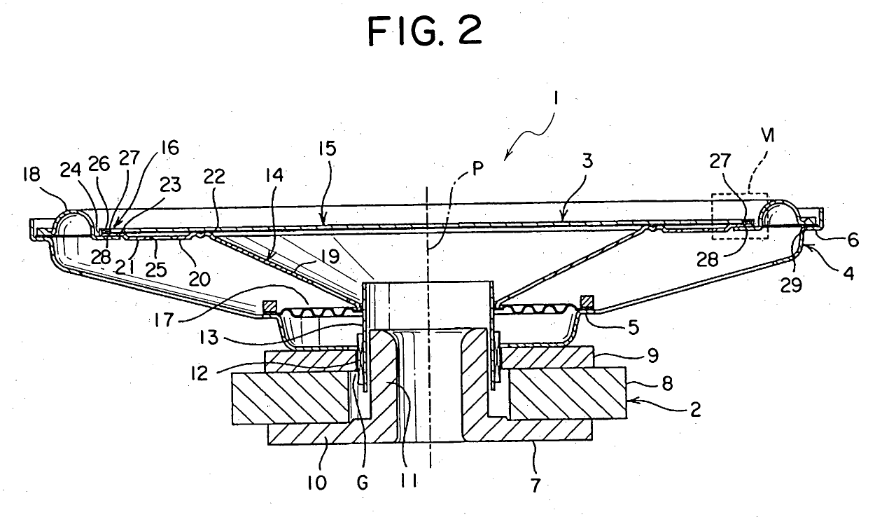

As shown in FIGS. 1 and 2, the speaker 1 includes a cabinet (not shown), a magnetic circuit 2, and a vibration portion 3 vibrated with the magnetic circuit 2 for generating sound.

The cabinet includes a cabinet main body (not shown) with a flat box shape and a retainer frame 4 (in FIG. 2). The cabinet main body has an opening to expose a diaphragm 15 of the vibration portion 3. The opening is communicated with an interior and exterior of the cabinet. The cabinet has a configuration such that the speaker 1 is attached to the cabinet main body having the flat box shape through the retainer frame 4.

The retainer frame 4 is formed from a thick metal plate, and includes a frame main body 5 with a truncated conical shape and a flange 6 outwardly extending from an outer edge of the main body 5. The frame main body 5 is formed in an annular shape and has an outer edge with an oval planar shape. The frame main body 5 of the retainer frame 4 is received in the cabinet main body and the flange 6 thereof is fixed to the cabinet main body.

The magnetic circuit 2 is received in the cabinet and includes, as shown in FIG. 2, a yoke 7 formed from a magnetic material such as paramagnetic or ferromagnetic material, a magnet 8, and a yoke plate 9 formed from a magnetic material such as paramagnetic or ferromagnetic material. The yoke 7 includes an annular bottom plate 10 and a cylindrical tube 11 upstanding from an inner edge of the annular bottom plate 10.

The magnet 8 has an annular shape and an inner diameter larger than an outer diameter of the tube 11. The magnet 8 is superposed on the bottom plate 10 and allows the tube 11 to pass therethrough. The magnet 8 is excited with a permanent magnet or a direct current.

The yoke plate 9 has an annular shape and an inner diameter larger than the outer diameter of the tube 11. The yoke plate 9 is superposed on the magnet 8 and allows the tube 11 and a voice coil bobbin 13 to pass through the center portion thereof. The yoke 7, magnet 8, yoke plate 9 are coaxially disposed to each other. Inner surfaces of the magnet 8 and yoke plate 9 have a spacing against an outer surface of the tube 11 of the yoke 7.

The magnetic circuit 2 is an outer magnet type and has a magnetic gap G between the outer surface of the tube 11 of the yoke 7 and the inner surface of the yoke plate 9 for generating a magnetic field to drive (vibrate) a drive cone 14 and a diaphragm 15 in cooperation with a voice coil 12. The magnetic circuit 2 vibrates the drive cone 14 and the diaphragm 15 in cooperation with the voice coil 12.

An inner edge portion of the retainer frame 4 is superposed on the yoke plate 9 and fixed together.

The vibration portion 3 is received in the cabinet, and includes the voice coil 12, the voice coil bobbin 13, the drive cone 14, the diaphragm 15, positioning portions 16, a damper 17, and an edge 18. The voice coil 12 is disposed in the magnetic gap G and accepts signal current.

The voice coil bobbin 13 has a tube shape, and an inner diameter larger than the outer diameter of the tube 11 of the yoke 7 and an outer diameter smaller than the inner diameter of the yoke plate 9. The voice coil bobbin 13 is coaxial with the yoke 7, the yoke plate 9, and the voice coil 12. One end portion of the voice coil bobbin 13 is inserted in the magnetic gap G and attached with the voice coil 12 around an outer surface of the one end. The voice coil bobbin 13 is movably supported with the drive cone 14 and the edge 18 along an axis P of the yoke 7, denoted dash-dotted lines in FIG. 2. The axis P is also the axis of the speaker 1.

The drive cone 14 is formed from a synthetic resin and has integrally a cone main body 19 and a flange 20. The cone main body 19 has a shape of a truncated cone and an inner edge thereof is attached to an inner edge of the damper 17. The cone main body 19 or the drive cone 14 is attached to the voice coil 12 through the damper 17 and the voice coil bobbin 13.

The flange 20 has an oval planar shape same as that of the retainer frame 4 and is connected to the cone main body 19 and extends outwardly from an outer edge of the cone main body 19. The flange 20 includes a flange main body 21, an inner edge protrusion 22 projecting from the flange main body 21 toward the diaphragm 15, an outer edge protrusion 23, and an upstanding segment 24.

The flange main body 21 has a plurality of through holes 25 disposed between the inner edge protrusion 22 and the outer edge protrusion 23. The through holes 25 are arranged equally spaced around the flange main body 21.

The inner edge protrusion 22 is disposed all around an inner edge portion of the flange main body 21 and projects toward the diaphragm 15 more than the flange main body 21. An upper surface of the inner edge protrusion 22 is flat.

The outer edge protrusion 23 is disposed all around an outer edge portion of the flange main body 21 and projects toward the diaphragm more than the flange main body 21 and the inner edge protrusion 22. An upper surface of the outer edge protrusion 23 is formed in a flat shape. The outer edge protrusion 23 or the drive cone 14 is superposed with an outer edge portion of the diaphragm 15. When they are superposed together, a spacing therebetween is formed. The flange main body 21 has a large dimension than the diaphragm 15.

The upstanding segment 24 is disposed all around an outer edge of the flange main body 21 or an outer edge portion of the drive cone 14, and extends to the side of the diaphragm 15. The upstanding segment 24 has a spacing with respect to an outer edge 15a of the diaphragm 15 superposed on the outer edge protrusion 23.

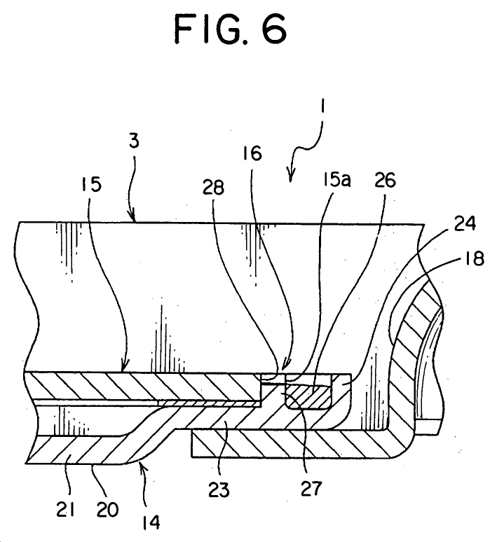

The diaphragm 15 is made of a metal and formed into a flat shape. The diaphragm 15 has an oval planar shape same as that of the drive cone 14 and has a slightly smaller dimension than the drive cone 14. As shown in FIG. 6, the outer edge portion of the diaphragm 15 is superposed on the outer edge protrusion 23 or the outer edge portion of the drive cone 14 applied with an adhesive agent 26. The adhesive agent 26 is filled between the outer edge 15a and the upstanding segment 24 to fix the diaphragm 15 to the drive cone 14. The positioning portions 16 each have a protrusion 27 projecting upwardly from the drive cone 14 and a cutout portion 28 disposed on the diaphragm 15 as an interference portion. The embodiment shows two protrusions 27 having a cylindrical shape and upstanding from the outer edge portion of the outer edge protrusion 23. The two protrusions 27 are opposed to each other with respect to the axis P and equally spaced around the drive cone 14.

The cutout portions 28 (interference portions) each are formed by cutting out a part of the outer edge portion of the diaphragm 15. When the outer edge portion of the diaphragm 15 is superposed on the outer edge protrusion 23 of the drive cone 14, the protrusions 27 are positioned inside the cutout portions 28. As shown in FIG. 4, the protrusion 27 is positioned in the cutout portion 28 and interferes (contacts) the surface of the cutout portion 28 so that the substantially equal spacing between the upstanding segment 24 and the outer edge 15a around the drive cone 14 and the diaphragm 15 position the drive cone 14 and the diaphragm 15.

The damper 17 has an annular and flat shape and the inner edge thereof is attached to the voice coil bobbin 13 and an outer edge thereof is attached to an inner surface of the retainer frame 4. An inner edge of the drive cone 14 is attached to the damper 17. The damper 17 allows the voice coil bobbin 13, or the drive cone 14 and the diaphragm 15 to vibrate along the axis P, and attenuates the vibrations thereof.

The edge 18 has an annular and flat shape and an inner edge portion thereof is attached to the outer edge portion of the drive cone 14 and an outer edge portion thereof is attached to the outer edge portion of the retainer frame 4. The edge 18 is fixed to the retainer frame 4 with the adhesive agent. The edge 18 allows the voice coil bobbin 13, or the drive cone 14 and the diaphragm 15 to vibrate along the axis P, and attenuates the vibrations thereof.

When the voice coil 12 disposed inside the magnetic gap C accepts the signal current, the voice coil 12 vibrates along the axis P. The voice coil bobbin 13 supporting the voice coil 12 vibrates along the axis P together with the drive cone 14 and the diaphragm 15 to generate sound in response to the signal current. The magnetic circuit 2 thereby generates the sound with vibrations of the drive cone 14 and the diaphragm 15, or the vibration portion 3.

In the present invention, the upstanding segment 24 is disposed at the outer edge portion of the drive cone 14 with the spacing from the outer edge 15a of the diaphragm 15. The adhesive agent 26 is filled between the upstanding segment 24 and the outer edge 15a of the diaphragm 15 to fix the diaphragm 15 and the drive cone 14. The adhesive agent 26 bonding the diaphragm 15 and the drive cone 14 thereby becomes visible so that it is easily to check occurrence of crack in the adhesive agent 26. It thus becomes easy to see a cause to deteriorate the sound characteristics of the speaker 1.

The adhesive agent 26 filled between the upstanding segment 24 and the outer edge 15a of the diaphragm 24 prevents direct contact therebetween regardless of a flatness of the drive cone 14 and the diaphragm 15, and is thus assuredly applied between the upstanding segment 24 and the outer edge 15a of the diaphragm 15, The drive cone 14 and the diaphragm 15 are thus bonded together with the adhesive agent 26 without crack. When the diaphragm 15 vibrates or generates the sound, the sound propagates air in the crack of the adhesive agent 26 resulting to the deterioration of the sound characteristics. The present invention prevents the deterioration thereof by suppressing the crack.

The speaker of the present invention has the positioning portions 16 for positioning the drive cone 14 and the diaphragm 15 so as to keep the spacing between the upstanding segment 24 and the outer edge 15a of the diaphragm 15 equal around the speaker 1 and to keep the thickness of the adhesive agent 26 boding the drive cone 14 and the diaphragm 15 uniform around the speaker 1. The occurrence of an extremely thin portion of the adhesive agent 26 is prevented so that the crack in the adhesive agent 26 is assuredly prevented.

The positioning portions 16 each include the protrusion 27 projecting from the drive cone 14 and the cutout portion 28 disposed on the diaphragm 15 so as to assuredly position the drive cone 14 and the diaphragm 15.

The flange 20 of the drive cone 14 includes the outer edge protrusion 23 projecting from the flange main body 21 and the inner edge protrusion 22 so that the diaphragm 15 is prevented from contacting the whole of the flange 20 and the contact portion between the flange 20 of the drive cone 14 and the diaphragm 15 is assuredly positioned on the outer edge protrusion 23 and the inner edge protrusion 22. The random contact portions between the flange 20 and the diaphragm 15 are prevented even when the surface of the flange 20 and the diaphragm 15 is rough.

The outer edge protrusion 23 projects more than the inner edge protrusion 22 does, and the drive cone 14 and the diaphragm 15 contact at the outer edge protrusion 23 each other so that the contact portion between the flange 20 and the diaphragm 15 is formed without randomness even that the flatness of the flange 20 and the diaphragm 15 is low.

The through holes 25 penetrating the flange main body 21 are disposed between the outer edge protrusion 23 and the inner edge protrusion 22 so that when the adhesive agent is applied to the outer edge protrusion 23, a solvent of the adhesive agent easily diffuses outside through the through holes 25, resulting to a shortening of hardening thereof and a shortening of assembly of the speaker 1.

Each positioning portion 16 includes the protrusion 27 projecting from the drive cone 14, and the cutout 28 disposed on the diaphragm 15. The positioning portion 16 may include a protrusion projecting from the diaphragm 15 toward the drive cone 14, and a recess disposed on the drive cone 14 for interfering the protrusion. The interfering portion can be a hole or recess beside the cutout 28.

The upstanding segment 24 are upstanding from the outer edge of the drive cone 14. The upstanding segment 24 can be disposed on any position of the outer edge portion of the drive cone 14 as far as the spacing against the outer edge 15a of the diaphragm 15 is kept. The outer edge protrusion 23 and the inner edge protrusion 22 can be projected by the same amount of the projection.

The embodiment described above achieves the following speaker 1.

Appendix: The speaker includes the voice coil 12 accepting the current signal, the drive cone 14 attached to the voice coil 12, the diaphragm 15 attached to the drive cone 14, the magnetic circuit 2 to vibrate the drive cone 14 and the diaphragm 15 in cooperation with the voice coil 12, wherein the drive cone 14 and the diaphragm 15 are superposed together at the outer edge portions thereof and fixed together with the adhesive agent, the upstanding segment 14 is upstanding from the outer edge portion of the drive cone 14, having the spacing with respect to the outer edge 15a of the diaphragm 15, and the adhesive agent 26 is filled between the upstanding segment 15 and the outer edge 15a of the diaphragm 15 to fix the drive cone 14 and the diaphragm 15 together.

The adhesive agent 26 bonding the diaphragm 15 and the drive cone 14 is visible so that the crack in the adhesive agent 26 can be easily inspected. The cause to deteriorate the audio characteristics of the speaker 1 can be easily inspected with eyes.

The adhesive agent 26 is filled between the upstanding segment 24 and the outer edge 15a of the diaphragm 15 having the spacing therebetween so that the contact therebetween is prevented regardless of the flatness thereof. The adhesive agent 26 is fully applied between the upstanding segment 24 and the outer edge 15a of the diaphragm 15 without unapplied area. The crack of the adhesive agent 26 of the speaker 1 can be thus prevented.

The embodiment described above is only exemplary and the present invention is not limited thereto and includes any modification and alteration within the scope of the present invention.

What is claimed is:

1. A speaker comprising:
a voice coil for accepting a signal current;
a drive cone attached to the voice coil;
a diaphragm attached to the drive cone;
a magnetic circuit for vibrating the drive cone and the diaphragm in cooperation with the voice coil; wherein
the drive cone and the diaphragm are superposed each other at outer edge portions thereof and fixed together with an adhesive agent,
the drive cone has an upstanding segment at the outer edge thereof, the upstanding segment being spaced from the outer edge of the diaphragm, and
the adhesive agent is filled between the upstanding segment and the outer edge of the diaphragm to fix the drive cone and the diaphragm together.

2. The speaker as claimed in claim 1, further comprising a positioning portion for positioning the drive cone and the diaphragm.

3. The speaker as claimed in claim 2, wherein the positioning portion includes a protrusion disposed on one of the drive cone and the diaphragm, and an interference portion disposed on the other thereof for interfering the protrusion, the protrusion protruding toward the interference portion.

4. The speaker as claimed in claim 1, wherein the drive cone includes a cone main body having a truncated cone shape and an annular flange connected with an outer edge of the cone main body,
the flange comprising:
an annular flange main body;
an inner edge protrusion disposed on an inner edge portion of the flange main body and projecting from the flange main body toward the diaphragm; and
an outer edge protrusion disposed on an outer edge portion of the flange main body and projecting from the flange main body toward the diaphragm and superposed with an outer edge portion of the diaphragm.

5. The speaker as claimed in claim 4, wherein the outer edge protrusion projects from the flange main body toward the diaphragm more than the inner edge protrusion projects.

6. The speaker as claimed in claim 4, further comprising a through hole disposed between the outer edge protrusion and the inner edge protrusion and penetrating the flange main body.
